(19) United States
(12) Patent Application Publication
(10) Pub. No.: US 2013/0101287 A1
(43) Pub. Date: Apr. 25, 2013

(54) Optical Interface Device for Wavelength Division Multiplexing Networks

(71) Applicants: David Jeffrey Graham, Sewickley, PA (US); David Markham Drury, Pittsburgh, PA (US); Eric John Helmsen, Wexford, PA (US)

(72) Inventors: David Jeffrey Graham, Sewickley, PA (US); David Markham Drury, Pittsburgh, PA (US); Eric John Helmsen, Wexford, PA (US)

(73) Assignee: ACCIPITER SYSTEMS, INC., Pittsburgh, PA (US)

(21) Appl. No.: 13/276,924

(22) Filed: Oct. 19, 2011

(51) Int. Cl. H04J 14/02

(52) U.S. Cl. 398/48

(57) ABSTRACT

A switch port device for transmitting and receiving optical bursts over an optical burst network. The switch port device includes a first end device interface configured to receive incoming data from a first end device and intended for a destination device, a processing device operably connected to the first end device interface and configured to control the modulation of the incoming data to a wavelength associated with the destination device to produce a modulated burst, an optical transmitter operably connected to the processing device and configured to transmit the modulated burst to an optical core, and an optical receiver operably connected to the processing device and configured to receive at least one incoming optical burst from the optical core.

### BACKGROUND

The disclosed embodiments generally relate to the fields of optical networks, data switching and data routing. More specifically, the disclosed embodiments generally relate to an optical interface for operably connecting a switch or routing device to an end device.

Recently, telecommunication systems and data networking systems have rapidly grown in speed and capacity. Accompanying the growth of these systems, however, has been the cost of maintaining these systems. A typical network, such as a local area network (LAN), requires a large and costly infrastructure. For example, groups of servers must be included in the LAN to handle requests from users of the LAN, direct these requests accordingly, maintain various shared files and other resources, and provide a gateway to other networks, such as the Internet. In addition to the servers, each LAN must have a series of routers and switches to direct traffic generated by the users of the LAN. The servers, switches and routers, as well as the users' computers must all be connected via cabling or a wireless connection. These various devices and connections all require significant power, cooling, space and financial resources to ensure proper functionality.

Fiber optic cables have been used to replace standard coaxial or copper-based connections in communication networks. Fiber optic cables typically use glass or plastic to propagate light through a network. Specialized transmitters and receivers utilize the propagating light to send data through the fiber optic cables from one device to another. Fiber optic cables are especially advantageous for long-distance communications, because light propagates through the fibers with little attenuation as compared to electrical cables. This allows long distances to be spanned with few repeaters, thereby reducing the cost of a communication network.

In fiber-optic communications, wavelength-division multiplexing (WDM) is a technology that multiplexes multiple optical carrier signals on a single optical fiber by using different wavelengths of light to carry the different signals. In this way, WDM allows for a multiplication in capacity.

A WDM system typically uses a multiplexer to join multiple optical carrier signals together at a transmitter, and a demultiplexer at the receiver to split the multiplexed signal into its original optical carrier signals. WDM systems are generally broken into three different wavelength patterns: conventional, coarse and dense.

Conventional WDM systems employ channel spacing on the order of 400 MHz and typically use wavelengths in the “C” band between 1530 and 1565 nm (see Table 1 below). The channel spacing, however, restricted the number of multiplexed wavelengths to between 8 and 16.

Dense Wave Division Multiplexing (DWDM) also refers to optical signals multiplexed within the 1530-1565 nm “C” band, but with much closer channel spacing and, therefore, the ability to multiplex additional optical channels. 100 GHz spacing, resulting in 40 channels, and 50 GHz channel spacing, resulting in 80 channels in the “C” band, are both common for DWDM systems, with some DWDM systems supporting alternative channel spacing such as 25 GHz.

Alternatively, coarse WDM (CWDM) systems use the entire frequency band from 1260 to 1675 nm with 20 nm channel spacing, thereby resulting in lower cost and less sophisticated transceiver designs.

Table 1 provides a list of band designations specified by the International Telecommunication Union for the main transmission regions of fiber optic cables and the wavelength ranges covered by each transmission region. Typically, DWDM falls into the 1530-1565 nm range, however, advances in materials and construction methods for optical fibers has increased this range to nearly the entire range of main transmission regions, i.e., 1260-1675 nm.

TABLE 1
ITU Standard Optical Band Definitions

| Band | Descriptor | Wavelength Range |
|---|---|---|
| O band | Original | 1260-1360 nm |
| E band | Extended | 1360-1460 nm |
| S band | Short Wavelength | 1460-1530 nm |
| C band | Conventional | 1530-1565 nm |
| L band | Long Wavelength | 1565-1625 nm |
| U band | Ultralong Wavelength | 1625-1675 nm |

As both communication systems grow and fiber optic systems become more integrated into standard communications, the speed, and resultant cost, of individual network components is also growing. Huge investments must be made by telecommunication companies to keep up with consumer demand as well as technological developments. As a result, telecommunication companies as well as businesses running their own communication networks would benefit greatly from network components with reduced size, weight, cost and power requirements. However, development has progressed slowly in this area. Instead, network components are simply made bigger and heavier, and consume more power in the pursuit of supplying higher bandwidth.

In atypical environments, such as airborne or shipborne networks, size, weight and power become even more important for network design. However, the lack of progress in reducing the size, weight and power of network components described above has restricted the availability of high-bandwidth networks in such environments.

For example, space is at a premium on most airplanes and smaller ships. As such, network components of the size used in most business environments could exceed the available storage space in such environments. Data networks capable of providing on-demand video and audio programming to airplane passengers have developed slowly at least because of the size of conventional networking equipment. Similarly, military aircraft often require high-speed communication between subsystems or are used as a flying communication hub. However, conventional networking equipment is limited in its ability to perform this task because of the limited footprint that can be provided to all functions in an aircraft.

In addition, the weight of a network component has a direct effect on fuel consumption in airborne or shipborne environments because the added weight increases the drag on the airplane or ship. Similarly, the amount of power consumed by network components directly affects fuel consumption since power in airborne and shipborne environments is generated within the environment itself. For ships that are at sea for long periods of time, the power consumed by conventional networking equipment inhibits the ability to use such equipment because of the drain on limited energy reserves.

Prior art approaches at reducing the size of switching components generally require data routing at the network core, resulting in buffering (and inherent latency) to queue the data flows at the core. Alternatively, prior art approaches have eliminated some switching functions by establishing direct, out-of-band connections. However, this arrangement requires time consuming and complex setup and tear down operations.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a switch port device. The switch port device includes a first end device interface configured to receive incoming data from a first end device and intended for a destination device, a processing device operably connected to the first end device interface and configured to control the modulation of the incoming data to a wavelength associated with the destination device to produce a modulated burst, an optical transmitter operably connected to the processing device and configured to transmit the modulated burst to an optical core, and an optical receiver operably connected to the processing device and configured to receive at least one incoming optical burst from the optical core.

In another general respect, the embodiments disclose a method of switching data bursts on an optical burst network. The method includes receiving, at a switch port device, data from at least one end device; assigning, by the switch port device, at least one wavelength to the data, wherein the wavelength is based upon a destination of the data; and transmitting, by the switch port device, the data as an optical burst on the at least one assigned wavelength to an optical core.

### BRIEF DESCRIPTION OF THE DRAWINGS

FIG. 1 illustrates an exemplary optical network according to an embodiment.

FIG. 2 illustrates an exemplary switch for use in the network of FIG. 1 including a switch port device according to an embodiment.

FIG. 3 illustrates the switch port device of FIG. 2 according to an embodiment.

FIG. 4 illustrates an exemplary process for implementing the switch port device of FIG. 3 according to an embodiment.

### DETAILED DESCRIPTION

The following terms shall have, for the purposes of this application, the respective meanings set forth below.

A “burst” refers to a sequence of bits of information transmitted by a node, a burst including, but not limited to, raw data, framed data, or data arranged into packets prior to transmission. A burst may be transmitted from one node to one or more destination nodes over a network.

A “node” refers to system (e.g., processor-based, field programmable gate array (FPGA) based or memory-based) configured to transmit and/or receive information from one or more other nodes via a network. For example, a node may transmit to one or more destination nodes by varying the frequency of its transmissions to match a frequency at which its burst is switched to a specific destination node.

A “switch” refers to a network component that provides bridging and/or switching functionality between a plurality of nodes. A switch may have a plurality of inputs and a corresponding number of outputs. Each node may be operably connected to a switch via both an input fiber and an output fiber.

An “Optical Burst” (OB) network refers to a network constructed from a plurality of nodes and one or more switches. An OB network uses optical transmissions to send data bursts between a source node and one or more destination nodes.

An “end device” is a network component that exists at the edge of a network. End devices may be components that end users interact with to access the network, including, but not limited to, computers and workstations. An end device may also be a component that an end user does not directly interact with, including, but not limited to, email servers and web servers. An end device may include one or more end device interfaces for operably connecting to the network.

Terabit Optical Ethernet (“TOE”) is a network architecture and transmission protocol that may be used to implement local, wide and/or metropolitan area networks. An exemplary TOE may be found in U.S. Pat. No. 7,751,709 filed Jan. 18, 2006 and entitled “Method and System for Interconnecting End Systems over an Optical Network,” the contents of which are hereby incorporated by reference. TOE may transmit 100s of terabits of information per second over single mode fibers that are common today. TOE is a highly scalable architecture allowing controlled access to a common shared fiber media.

In the present disclosure, the underlying principles of TOE have been used to provide an alternative architecture providing a better match to specific requirements of large, concentrated assemblies of processors and storage devices in an OB network.

An OB network resolves these problems by removing layers of conventional infrastructure equipment. Moreover, power, cooling and packaging costs are dramatically reduced as a result of the reduction in physical infrastructure. In addition, an OB network is easily scalable and can benefit from increases in optical technologies for improved bandwidth over time. An OB network is inherently transparent to the nature of the bursts carried over it, and may be designed to carry Ethernet traffic by providing Ethernet interfaces to connected computer systems, Peripheral Component Interconnect (PCI) Express traffic through PCI Express interfaces, Fiber Channel through Fiber Channel interfaces, and so forth. OB and methods of using OB networks to reduce network costs by interfacing various computer systems via an optical switch are discussed below with reference to the figures.

An exemplary OB network as discussed herein may include at least three basic elements: a plurality of nodes, at least one switching device and a plurality of optical fibers. Each node may include one or more transceivers used to access the optical fibers. An optical transceiver may be an integrated circuit configured to transmit and receive a signal via an optical fiber. An optical fiber is typically a glass or plastic tube configured to carry an optical signal. In the exemplary OB network as discussed herein, an optical fiber (single-mode or multi-mode) may be used to link each node to the switching device, thereby establishing a network, such as a LAN.

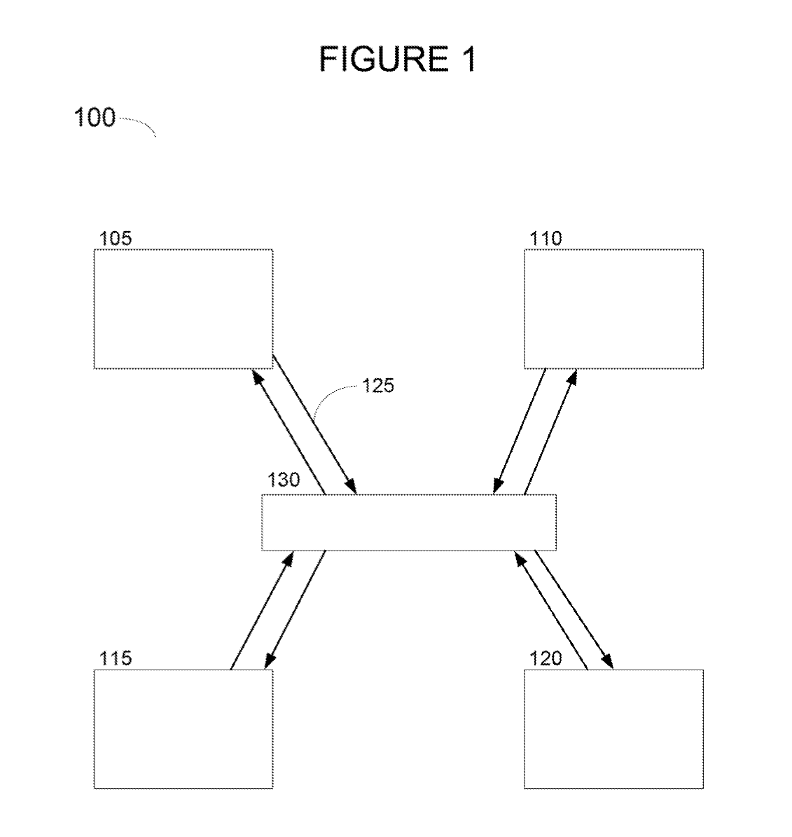

FIG. 1 illustrates a system level diagram of an exemplary OB network 100. The OB network 100 may include four nodes 105, 110, 115 and 120 interconnected by a series of links 125 to a switch 130. The links may include electrical connections, optical connections such as single mode and multimode optical fibers, or other similar operable connections. Each node may be connected to both an input terminal and an output terminal of the switch 130.

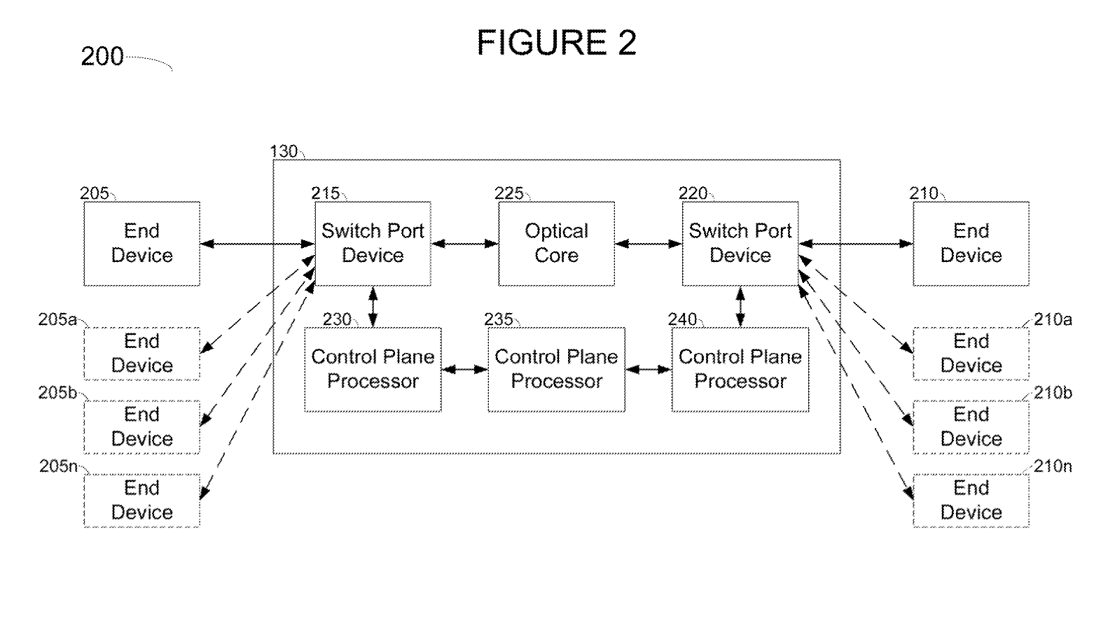

In order for one node to transmit data to another node, the source node transmits data to the switch with the intended destination information contained within that data stream. For example, node 105 may send data intended for node 120. The node 105 may transmit the data through switch 130. The switch 130 may receive the data and directs the data to the output destination node 120 accordingly. The internal architecture of the switch 130 is discussed in greater detail below with respect to FIG. 2.

FIG. 2 illustrates an exemplary OB network 200 including an exemplary architecture for the switch 130. The switch 130 may be operably connected to a first end device 205 (e.g., one of nodes 105, 110, 115 and 120) and a second end device 210 (e.g., one of nodes 105, 110, 115 and 120).

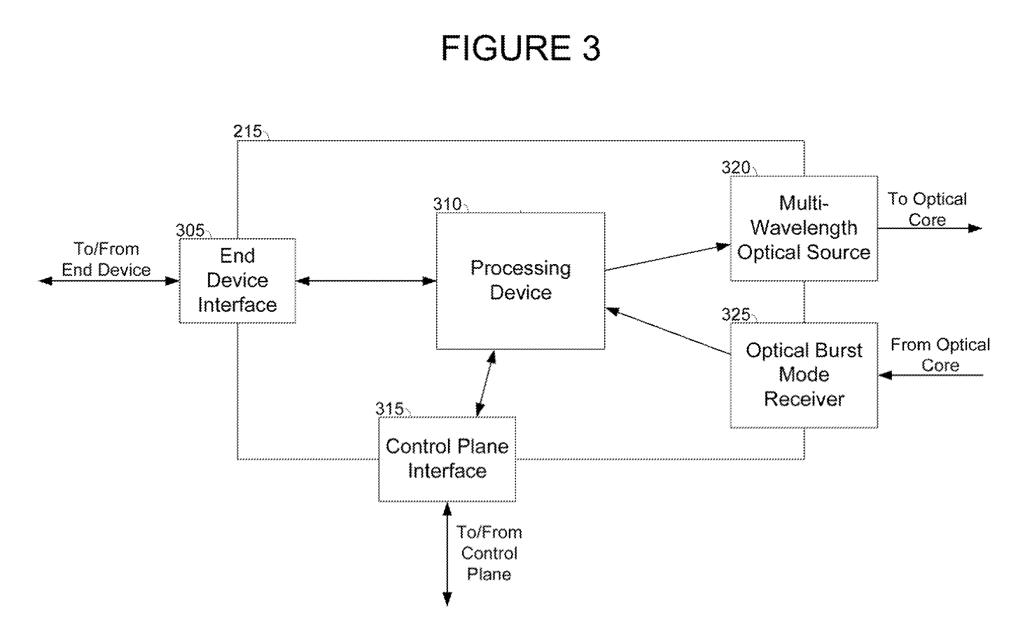

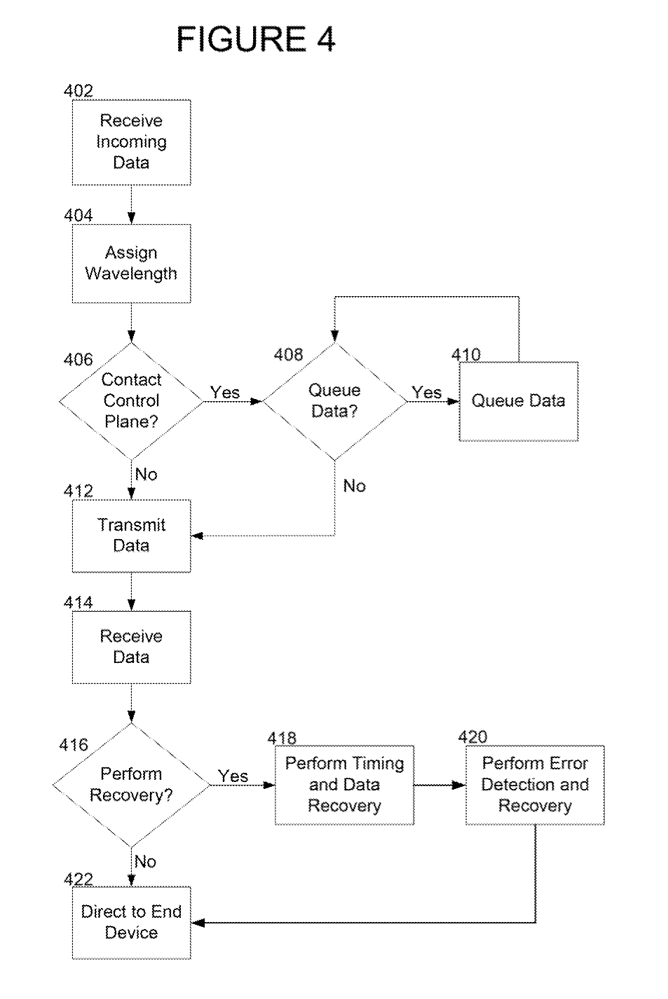

Each of the end devices 205 and 210 may be operably connected to one of switch port device 215 and switch port device 220 respectively. A switch port device is an optical interface device configured to operably connect end devices to the optical core. Each switch port device 215 and 220 may be configured to receive incoming data from an end device, determine the destination of the data (e.g., one of nodes 105, 110, 115 or 120 as shown in FIG. 1), and modulate the data into a burst of the appropriate wavelength or wavelengths such that the burst reaches the intended destination switch port device(s), where the burst is reformatted into data for transmission to the appropriate end device(s). Additional detail related to the architecture and functionality of the switch port devices 215 and 220 is discussed in reference to FIGS. 3 and 4.

Referring to FIG. 2, each of switch port devices 215 and 220 may be operably connected to an optical core 225 and one or more control plane processors 230, 235 and 240. The optical core may be configured to switch and direct data bursts based upon their wavelength. An example of an optical core is shown in U.S. patent application Ser. No. 13/035,045 filed Feb. 25, 2011 and titled “Optical Switch for Implementing Wave Division Multiplexing Networks,” the content of which is hereby incorporated by reference in its entirety. The control plane processors 230, 235 and 240 may be configured to control data flow from the switch port devices 215 and 220 to the optical core 225. The control plane processors 230, 235 and 240 may schedule transmissions over the optical core such that only one burst is being sent to a single destination at one time, thereby eliminating the chances of a burst being lost during transmission. An example of a control plane processor functioning in concert with an optical core is shown in U.S. application Ser. No. 13/276,805 filed Oct. 19, 2011 and titled “Optical Switch for Networks Using Wavelength Division Multiplexing,” the content of which is hereby incorporated by reference in its entirety.

It should be noted the arrangement and architecture of OB network as shown in FIG. 2 is shown by way of example only. The number of end devices may be determined based upon several factors such as the functionality of the switch 130 or the overall architecture of the OB network 200. For example, the end devices discussed with regard to FIG. 2 have been limited to end devices 205 and 210 for explanatory purposes. However, as illustrated in FIG. 2, additional end devices 205a, 205b, . . . , 205n may be operably connected to switch port device 215, and additional end devices 210a, 210b, . . . , 210n may be operably connected to switch port device 220. Additionally, three control plane processors 230, 235 and 240 are shown by way of example only. In an alternative embodiment, a single control plane processor may by used to control data flow through the optical core. The number of control plane processors may be determined by the layout of the OB network as well as the amount of traffic and related information to be processed, and thus may vary depending on the application and design of the network.

Similarly, the placement of the switch port devices 215 and 220 are shown by way of example only. In alternative embodiment, the switch port devices may be integrated in the end devices as a network interface card (NIC) such as a PCI Express NIC. Similarly, the switch port devices may be a stand-alone unit such as a top-of-rack fabric extender on a server rack. The switch port device may also be integrated in the optical core itself, for example, as a line card.

FIG. 3 illustrates an exemplary architecture for a switch port device such as switch port device 215 as shown in FIG. 2. The switch port device 215 may include an end device interface 305 for operably connecting to an end device such as end device 205 as shown in FIG. 2. The end device interface 305 may be configured to establish bi-directional communication between the switch port device 215 and the end device. The operable connection between the end device interface 305 and the end device may be media independent. For example, the connection may be electrical, optical, wireless, and so forth. The switch port device 215 may receive data from the end device via the end device interface 305 as raw and unformatted data, or formatted in an interconnect standard such as PCI Express, Fiber Channel, Ethernet, or another similar interconnect standard.

The end device interface 305 may be operably connected to computation and queuing logic, such as processing device 310. The processing device 310 may be configured to receive incoming data from the end device interface 305 and process the data for transmission to an intended destination device. Processing the data may include determining and assigning a wavelength for transmitting the data based upon an assigned wavelength for the intended destination. The processing device 310 may be an application specific integrated circuit (ASIC), a field-programmable gate array (FPGA), a microprocessor, or another similar processing device.

The processing device 310 may be further connected to a control plane interface 315 for sending information to and receiving information from a control plane processor. The processing device 310 may send an indication to the control plane via the control plane interface 315 indicating there is data to be sent to a destination node. The control plane interface 315 may receive scheduling information from the control plane processor indicating when the switch port device 215 can transmit the data to the optical core. Based upon the scheduling information, the processing device 310 may queue the data for a certain time period, or direct the data to a multi-wavelength optical source 320 for transmission to the optical core. The multi-wavelength optical source 320 may be a tunable laser configured to produce a signal on one of a plurality of wavelengths. Alternatively, the multi-wavelength optical source 320 may be a laser array including a plurality of lasers, each of which is tuned to a unique wavelength. The multi-wavelength optical source 320 may also be a combination of tunable lasers and a laser array.

The switch port device 215 may also include an optical burst mode receiver 325 operably connected to the optical core and configured to receive incoming optical bursts from the optical core. The optical burst mode receiver 325 may include photo-detection circuitry such as an optical sensor for detecting the incoming optical bursts as well as timing and data recovery circuitry for the incoming optical bursts. The optical burst mode receiver may be further configured to pass any incoming optical bursts to the processing device 310 for further processing and forwarding to an appropriate end device as determined by the contents of the incoming optical bursts.

It should be noted the number and arrangement of components as shown in FIG. 3 is by way of example only and may be modified depending on the implementation of the switch port device 215. For example, multiple end device interfaces 305 may be included for connecting the switch port device 215 to a plurality of end devices, such as end devices 205a, 205b, . . . , 205n as shown in FIG. 2.

FIG. 4 illustrates an exemplary process for implementing a switch port device, such as switch port device 215, as shown in FIG. 3. The switch port device receives 402 incoming data from an end device. As discussed above, the incoming data may be raw and unformatted data, or formatted in an interconnect standard such as PCI Express, Fiber Channel, Ethernet, or another similar interconnect standard. The received data may include address information of other information indicative of the intended destination of the data. Based upon the intended destination(s), the switch port device may assign 404 a wavelength, or set of wavelengths, to the data.

The switch port device may determine 406 whether to contact the control plane processor regarding the data. If the switch port device does contact the control plane processor, the control plane processor may respond with scheduling information related to transmission of the data. Based upon the scheduling information, the switch port device may determine 408 whether to queue the data until the appropriate time for transmission. If the scheduling information indicates the switch port device is to transmit the data at a later time, the data is queued 410. Otherwise, the switch port device modulates the data to the assigned 404 wavelength and transmits 412 the data to the optical core. Similarly, if the switch port device determines 406 it does not need to contact the control plane, or switch port device determines 408 the data should not be queued, the switch port device may modulate and transmit 412 the data without queuing 410.

The switch port device may also receive 414 data from the optical core. Depending on the functionality and programming of the switch port device, the switch port device may determine 416 whether to perform recovery functions on the received 414 data. If the switch port device determines 416 to perform recovery, various timing and data recovery methods may be performed 418 such as timing checks and correction, data reassembly, and other similar functions to correct any timing or data issues caused by the transmission 412 of the data. The switch port device may further perform 420 error detection and correction on the received 414 data. Based upon the processing capabilities of the switch port device, one or both of the timing and data recovery 418 and the error detection and correction 420 may be performed.

The switch port device may direct 422 the received data, whether recovery was performed or not, to an appropriate end device as determined based upon the wavelength or set of wavelengths of the incoming data received 414 from the optical core as well as destination information contained within the data. Additionally, the switch port device may send a notification to the control plane processor including an acknowledgement of receiving 414 the data from the optical core.

Depending on the functionality and programming of the switch port device, the switch port device may further determine 416 to perform 418/420 layer 2 reliable delivery on the received 414 data. If the switch port device determines 416 to perform 418/420 reliable delivery, various reliable delivery methods may be performed such as SACK or Go-Back-N. Retransmission time-out may be support as well. The switch port device may direct 422 the received data, whether reliable delivery was performed 418/420 or not, to an appropriate end device as determined based upon the wavelength or set of wavelengths of the incoming data received 414 from the optical core as well as destination information contained within the data.

It should be noted that while the exemplary process as illustrated in FIG. 4 shows transmitting and receiving as a linear process, the process may progress in various manners and include fewer or more steps. For example, multiple transmissions may occur before receiving any data. Similarly, receiving data may occur prior to or simultaneous with transmission of data.

It should be noted that the control plane as discussed above in reference to FIGS. 2 and 3 may operate on separate wavelengths from the data plane while sharing common optic fibers. Alternatively, the control plane may operate with separate optic fibers from the data plane or operate on a completely separate communication medium such as copper wire. If on fiber, the control plane signals may be in parallel with data plane signals or in-band with data plane signals on different time allocations.

It should also be noted that the switch as shown in FIG. 2 may be modified accordingly based upon the requirements of a network that the switches are integrated into. It should also be noted that while the disclosed embodiments refer to switch data operating over Ethernet, the switches may also be used with alternate and/or additional networking protocols. For example, a switch, such as switch 130, may be integrated into an InfiniBand network or other computer cluster protocols, a Fiber Channel or other storage protocol (e.g., iSCSI) network, an Asynchronous Transfer Mode network, or another similar switched fabric network protocol configured to transfer data between nodes. It should also be noted that while the disclosed embodiments do not refer to switch data operating with any particular modulation technique, the switches may be used with alternate and/or additional modulation schemes. For example, a switch, such as switch 130, may be integrated into a network using OOK, QPSK, QAM, or other similar modulation techniques to transfer data between nodes.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A switch port device comprising:
a first end device interface configured to receive incoming data from a first end device and intended for a destination device;
a processing device operably connected to the first end device interface and configured to control the modulation of the incoming data to a wavelength associated with the destination device to produce a modulated burst;
an optical transmitter operably connected to the processing device and configured to transmit the modulated burst to an optical core; and
an optical receiver operably connected to the processing device and configured to receive at least one incoming optical burst from the optical core.

2. The switch port device of claim 1, further comprising a control plane interface operably connected to the processing device and configured to communicate with a control plane associated with the optical core.

3. The switch port device of claim 2, wherein the processing device is further configured to queue the incoming burst based upon an instruction from the control plane.

4. The switch port device of claim 2, wherein the processing device is further configured to transfer the modulated burst to the optical transmitter based upon a scheduling instruction from the control plane.

5. The switch port device of claim 1, further comprising a second end device interface configured to receive incoming data from a second end device.

6. The switch port device of claim 5, wherein the processing device is further configured to direct at least a portion of at least one of the incoming optical bursts to either the first end device or the second end device based upon a wavelength of the at least a portion of the at least one of the incoming optical bursts.

7. The switch port device of claim 1, wherein the optical transmitter is at least one of a tunable laser and a laser array.

8. The switch port device of claim 1, wherein the optical receiver is comprised of clock and data recovery circuitry for at least one incoming optical burst.

9. A method of switching data bursts on an optical burst network, the method comprising:
receiving, at a switch port device, data from at least one end device;
assigning, by the switch port device, at least one wavelength to the data, wherein the wavelength is based upon a destination of the data; and
transmitting, by the switch port device, the data as an optical burst on the at least one assigned wavelength to an optical core.

10. The method of claim 9, further comprising transferring, by the switch port device, information to a control plane processor related to the data.

11. The method of claim 10, further comprising receiving, by the switch port device, scheduling information from the control plane processor.

12. The method of claim 11, further comprising queuing, by the switch port device, the data based upon the scheduling information.

13. The method of claim 11, wherein the transmitting further comprises transmitting the data to the optical core based upon the scheduling information.

14. The method of claim 9, further comprising receiving, by the switch port device, at least one optical burst from the optical core.

15. The method of claim 14, further comprising performing, by the switch port device, error correction on the at least one optical burst.

16. The method of claim 14, further comprising directing, by the switch port device, at least a portion of the at least one optical burst to an end device based upon a wavelength of the at least a portion of the at least one optical burst.
